(19) United States
(12) Patent Application Publication
(10) Pub. No.: US 2009/0327396 A1
(43) Pub. Date: Dec. 31, 2009

(54) Tiny File Transfer Protocol (TFTP) Relay Agent

(75) Inventors: Anis M. Abdul, Austin, TX (US); Nikhil Hegde, Round Rock, TX (US); Ajay K. Mahajan, Austin, TX (US); Rashmi Narasimhan, Round Rock, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: INTERNATIONAL BUSINESS MACHINES CORPORATION, Armonk, NY (US)

(21) Appl. No.: 12/164,196

(22) Filed: Jun. 30, 2008

(51) Int. Cl. G06F 15/16

(52) U.S. Cl. 709/202

(57) ABSTRACT

One embodiment for dynamically loading a service onto a node includes requesting, by a service requester, of a service from a service broker. Further, the method includes selecting, by the service broker, of the node among the nodes. Further still, the method includes re-booting, by the service broker, of the node based on the selecting, and then requesting, by the node, of an image from a TFTP relay agent for the service for the node. Yet further, the method includes querying, by the TFTP relay agent, for a type of the service from the service broker for the node, and then downloading of the image for the type of the service from a software repository accessed by the TFTP relay agent to the node. Finally, the method includes booting, by the node, to the image, informing the service requester that the service is ready for use, and using the service.

### BACKGROUND OF THE INVENTION

Personal computer systems are well known in the art. They have attained widespread use for providing computer power to many segments of today's modern society. Personal computers (PCs) may be defined as a desktop, floor standing, or portable computer that includes a system unit having a central processing unit (CPU) and associated volatile and non-volatile memory, a display, an input-output device such as a keyboard and/or a mouse, a storage device such as a hard disk storage drive, and, in many instances, a network interface adapter. One of the distinguishing characteristics of these systems is the use of a motherboard or system planar to electrically connect these components together. Examples of such personal computer systems are IBM's PC 300 series, Aptiva series, and Intellistation series.

Computer systems typically communicate with network resources via local area networks (LANs), such as campus-area networks (CANs) or home-area networks (HANs), or via wide area networks (WANs), such as metropolitan-area networks (MANs) or the Internet. The widespread use of PCs in conjunction with networks has resulted in a reliance on the network resources, or other computer systems, for, just to name a few, telecommuting, obtaining news and stock market information, trading, banking, shopping, shipping, communicating in the form of Voice Internet protocol (VoiceIP) and email. For many, PCs represent an essential tool for their livelihood. In today's networked world, the availability and performance of the network is as important as the availability and performance of the personal computer. Thus, it is desirable to minimize loss of productivity by increasing availability of network resources.

A growing trend in large scale computing today is to have various services, e.g., audio player, video player, router, a hardware access routine, etc., provided by multiple nodes in a distributed computing environment. In such a complex environment, downloading a specific set of software on a node based on its location and specific service is required and is very useful, but is difficult to implement. This problem becomes more complicated if the nodes are diskless, i.e., cannot reboot themselves and must get their images from others, and receive their images from a common entity. Typically, a certain firmware is already loaded on the node. If one node is to provide just hardware access, then another set of firmware is loaded onto another node. So, no TFTP servers allow one to download two different images from the same server. Instead, a TFTP server normally only has one image, which is loaded on a node, and this disclosure provides solutions to change that by dynamically loading a service onto a node on a networked computer system, and, thereby permit multiple images from a TFTP server based on what the node requests for the service that the node is to supply.

### BRIEF SUMMARY OF THE INVENTION

Embodiments of this disclosure generally provide methods, systems, and media for dynamically loading a service onto a node on a networked computer system. One embodiment of the method includes requesting, by a service requester, of a service from a service broker. Further, the method includes selecting, by the service broker, of the node among the nodes on the networked computer system. Further still, the method includes re-booting, by the service broker, of the node based on the selecting and requesting, by the node, of an image from a TFTP relay agent for the service for the node. Yet further, the method includes querying, by the TFTP relay agent, for a type of the service from the service broker for the node, and downloading of the image for the type of the service from a software repository accessed by the TFTP relay agent to the node. Finally, the method includes booting, by the node, to the image, informing the service requester by the node that the service is ready for use, and using the service on now loaded on the node.

In another embodiment, this disclosure provides a system for dynamically loading a service onto a node on a networked computer system. The system includes a networked computer system comprising a service requester, a service broker, a TFTP relay agent, a software repository, and one or more nodes. The system's service requester requests a service from the service broker. The system's service broker selects the node among the one or more nodes and re-boots the node selected by the service broker. The system's node selected by the service broker requests an image from the TFTP relay agent for the service for the node. The system's TFTP relay agent queries the service broker for a type of the requested service, reads the system's software repository for the image, and then downloads the image for the type of the service from the system's software repository to the node. And, finally, the system's node selected by the service broker boots the image and informs the service requester that the service is now ready for use, e.g., the downloaded service, such as an audio or video filename, and now loaded onto the node may be used by the node having an audio or video player.

In yet another embodiment, this disclosure provides a machine-accessible storage medium containing instructions for dynamically loading a service onto a node on a networked computer system. The instructions generally include operations for requesting, by a service requester, of a service from a service broker. Further, the instructions include operations for selecting, by the service broker, of the node among the nodes on the networked computer system. Further still, the instructions include operations for re-booting, by the service broker, of the node based on the selecting and requesting, by the node, of an image from a TFTP relay agent for the service for the node. Yet further, the instructions include operations for querying, by the TFTP relay agent, for a type of the service from the service broker for the node, and downloading of the image for the type of the service from a software repository accessed by the TFTP relay agent to the node. Finally, the instructions include operations for booting, by the node, to the image, informing the service requester by the node that the service is ready for use, and using the service now loaded on the node.

### BRIEF DESCRIPTION OF THE SEVERAL VIEWS OF THE DRAWING

So that the manner in which the above recited features, advantages and objects of the present disclosure are attained and can be understood in detail, a more particular description of this disclosure, briefly summarized above, may be had by reference to the embodiments thereof which are illustrated in the appended drawings.

It is to be noted, however, that the appended drawings illustrate only typical embodiments of this disclosure and are therefore not to be considered limiting of its scope, for this disclosure may admit to other equally effective embodiments.

FIG. 1 depicts an example embodiment of a system for dynamically loading a service onto a node on a networked computer system in accordance with this disclosure.

FIG. 2 depicts an example embodiment of a method for dynamically loading a service onto a node on a networked computer system in accordance with this disclosure.

FIG. 3 depicts another example embodiment, through a sequence diagram, of a method and/or system for dynamically loading a service onto a node on a networked computer system in accordance with this disclosure.

FIG. 4 depicts a computer system capable of being a node for use in dynamically loading a service onto that node part of a non-depicted networked computer system in accordance with this disclosure.

### DETAILED DESCRIPTION OF THE INVENTION

The following is a detailed description of example embodiments of this disclosure depicted in the accompanying drawings. The embodiments are examples and are in such detail as to clearly communicate this disclosure. However, the amount of detail offered is not intended to limit the anticipated variations of embodiments; on the contrary, the intention is to cover all modifications, equivalents, and alternatives falling within the spirit and scope of the present disclosure as may be defined by the appended claims. The detailed descriptions below are designed to make such embodiments obvious to a person of ordinary skill in the art.

Generally speaking, methods, and media for dynamically loading a service onto a node on a networked computer system are contemplated. A service requester may request a service, e.g., programmable serial interface (psi), from a service broker, which may searches what nodes are present, free and available in the networked computer system. The service broker may select a particular node based on the search and reboot the selected node. The rebooted node requests a image from a TFTP relay agent, which informs the service broker that the selected node is requesting a software/firmware/operator system image (“image”) to perform the example psi service. The TFTP relay agent reads the image located on a software repository, and downloads that image onto the selected node. The selected node boots from the downloaded image that supports the example psi service, loads that image, and starts the service on the node, e.g., the psi service., that is now ready for use on the node for the desired service.

By way of further general discussion, this disclosure defines solutions using a broker to determine, for example, the service type and the file name, for loading onto a node, and thus coupling the service management and file download based on the hardware location. This allows a server requester to decide what services are being provided by a particular node based on the hardware location and a image that needs to be provide from a software repository having one or more images.

The process for service determination and image download may be viewed as two parts. First, the node that needs a specific service selects a node based on the location, as well as being free and available, to provide the service. Second, the tiny or trivial transfer protocol (TFTP) relay agent comprising one or more servers queries the service location to find the map for the image based on the node and service the node needs to provide.

The service broker tracks the hardware nodes present and their current status, i.e., whether free and available. When a node requests a particular device, the node looks at the current list of nodes and allocates one to be used for the service. The service broker also sends a message to the node to reload the image. When a node requests the image download, the TFTP relay agent queries the service broker for the service. Based on the service type, e.g., audio or video player, the TFTP relay agent extracts the image from the software repository and downloads the image to the node.

By way of the following examples, aspects of this disclosure may be further envisaged. Imagine there are fifteen different devices that can actually play video and music together. Prior to this disclosure, a ps3 device or node would play video and a psp device or node would play audio, and each would receive their images from a central server. With this disclosure, however, modularization of hardware based on what service is desired is possible. That is, one node may do any service and/or one node may do another node's function so long as the hardware is there to support it. Turning to the home environment for another example, one may have a PC, which may have a ps3, psp and and X-Box devices or nodes. From the PC, a user tells the ps3 node what to do, i.e., only download, and do not do video. So, the ps3 node will be re-booted and then be provided a new image, which will makes the ps3 node function like an ftp server and download data. The X-Box device will do nothing but receive the new image in order to play video. As a result of this disclosure, one no longer needs to receive an image and place it on a CD or a harddisk and boot therefrom. That is, one no longer needs to load the image onto the device by hand. Instead, the present disclosure allows for dynamic loading of an image onto a node. The nodes do not have pre-loaded images, but are loaded dynamically onto the selected node for the particular service because the abstracted images required to perform the particular service on the nodes are located on the software repository of the TFTP server accessed by the TFTP relay agent through use of a broker.

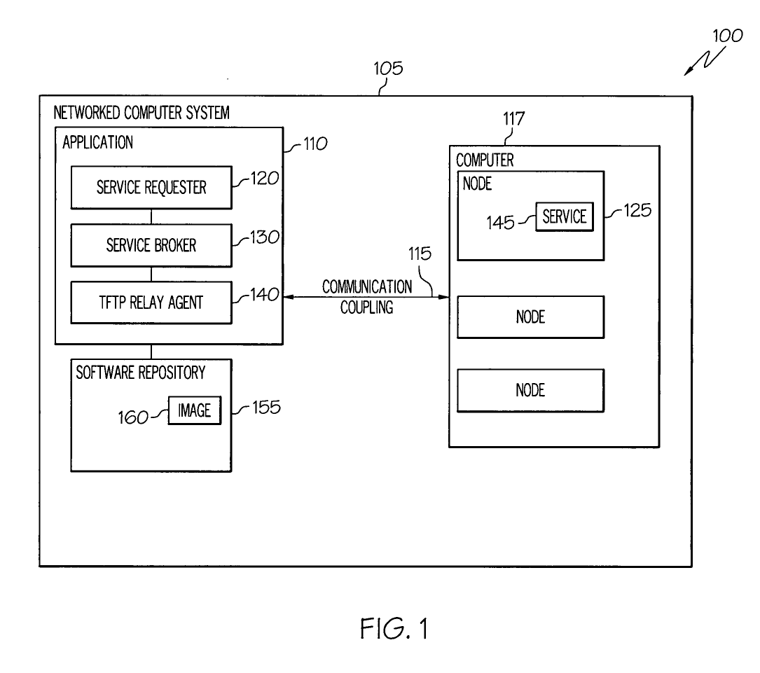

Turning now to the drawings, FIG. 1 depicts an example embodiment of a system 100 for dynamically loading a service 145 onto a node 125 on a networked computer system 105. The illustrative system 100 depicts three nodes, including node 125, but there may be one or more nodes in alternate, example embodiments. The nodes, including node 125, are discussed as being part of the networked computer system 105, and the depicted computer 117 may be one or more computers, such two node controllers being on each node, and computer 117 may comprise one or more PCs, workstations, PDAs, cell phones, and so forth. Returning to the system 100 depicted FIG. 1, the networked computer system 105 may have its 105 components coupled through hardwire, internet(s), Ethernet(s), intranet(s), and/or any other coupling known in the art for networking a networked computer system 105. Communication coupling 115, may be any of those just discussed, and is pointed out in FIG. 1 for clarity of this discussion. That is, the communication coupling 115 is shown on FIG. 1 to neatly show an example embodiment of how a node 125 may perform a particular service 145 by communicating 115 with an application 110 and software repository 155 for the node 125 to receive an image 160 to perform a particular service 145.

The system 100 depicts an application 110 on the networked computer system 110 coupled 115 to the computer 117 having a node 125 as well as other unnumbered nodes associated with the computer 117. The application 110, enabled by logic reduced to hardware and/or software, may actually be one or more applications, and may collectively and/or separately include a service requester 120, a service broker 130, and a TFTP relay agent 140. The point here is still the same: in various, example embodiments, the actual components of the networked computer system 110, have enabling logic reduced to hardware and/or software, may be parceled together in various embodiments, but the components are sill logically interconnected through enabling logic to permit transfer of the proper image 160 to a selected node 125 that is free and available to perform the desired service 145 required for a node 145 by transfer of that image 160 to the selected node 145.

Discussing FIG. 1 in more detail, the application 110 in the example embodiment includes a service requester 120 that requests a service 145, such as psi or ps3 , from a service broker 130. The service requester 120, which may be integral to or associated with the application 110, may be initiated by a user seeking to perform a service 145 that can be provided by a node 125. For instance, the service requester 120 may be providing streaming video to an end-user from the service 145, e.g., a video driver, on the node 125 if the image 160 downloaded to the node 125 is for video player or video device. Equally, the service 145 could be an audio driver if the image 160 downloaded to the node 125 is for audio player or audio device.

The service broker 130, through enabling logic, selects the node 125 among the one or more nodes in the computer 117, and for simplicity's sake of this discussion, the service broker 130 is said to select node 125 among the nodes on the computer 117 for the service 145 to be performed on the computer 117. Before the service broker 130 actually selects the node 125 among the one or more nodes on the computer 117, however, the service broker 130 searches among the nodes in order to select a node 125 that is free and available for performing the service 145. Thereafter, through further enabling logic reduced to software and/or hardware, the service broker 130 reboots the selected node 125.

As part of the reboot sequence, the selected node 125 requests an image 160 from a TFTP relay agent 140 for the service 145 for the selected node 125. The TFTP relay agent 140, having enabling logic reduced to software and/or hardware, may comprise one or more servers for querying the service broker 130 for a type, e.g., video or audio, of the service 145 for the now requested image 160 to tell the TFTP relay agent 140 which image 160 to read from an associated software repository 155 containing one or more images, including image 160, available for download by the TFTP relay agent 140 for the type of the requested service 145 to the selected node 125. As can be seen, the service broker 130 is analogous to a conductor of an orchestra comprised of components directed to provide a service 145 on a selected node 125, which may provide video and audio much like an orchestra.

After the image 160 from the software repository 160 accessed by the TFTP relay agent to the selected node 125, the example system 100 culminates by booting the selected node 125 to the downloaded image 160 as directed by the reboot sequence from the service broker 130. Thereafter, the node 125 informs the service requester 120 that the service 145 is ready for use, whereby the service requester 120 uses the service 145 on the node 125.

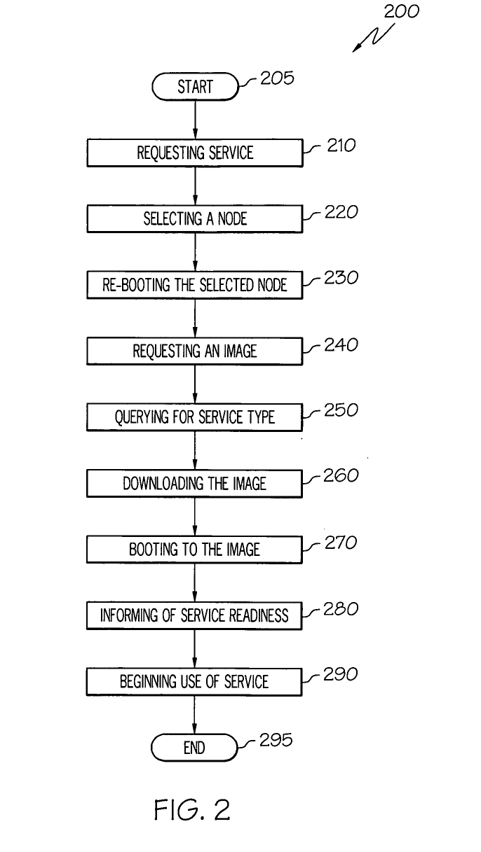

Turning now to FIG. 2, another aspect of the disclosure is disclosed. In particular, an embodiment of a flowchart 200 for dynamically loading a service onto a node on a networked computer system is depicted. Flowchart 200 is for a system, such as system 100, as shown in FIG. 1.

Flowchart 200 starts 205 by requesting 210 a service from a service broker. The service broker selects 220 a node by searching among the one or more nodes in the networked computer system that is free and available, i.e., a node is not currently being used and is capable of performing a service. In selecting 220 such a node, there may be one or many nodes, such as in IBM's system i/p servers, wherein a machine typically has eight nodes with two node controllers per node to prevent single point failure, and in such a configuration, it is understood that the node controllers behave as the nodes as described elsewhere herein, i.e., the node controllers are capable of providing a service if the image is downloaded thereto by the TFTP relay agent from the software repository.

Returning to flowchart 200, after selecting 220 the node among the one or more nodes possible in the networked computer system, the flowchart 200 continues by re-booting 230 the selected node by a service broker. The service broker requests 240, such as by communicating through one or more messages, an image from a TFTP relay agent for the service to be performed on the selected 240 node. The TFTP relay agent then queries 250 the service broker for a type of service for the selected 240 node, and locates the type of the service for the selected node through this querying 250. The TFTP relay agent downloads 260 the image for the type of the service from a software repository for and to the selected 240 node. The node boots 270 to the now downloaded 260 image from the software repository, and informs 280 the service requester that the selected 240 node is now ready for use. Finally, the flowchart 200 culminates in the node beginning 290 use of the service loaded onto the selected 240 node before the flowchart ends 295.

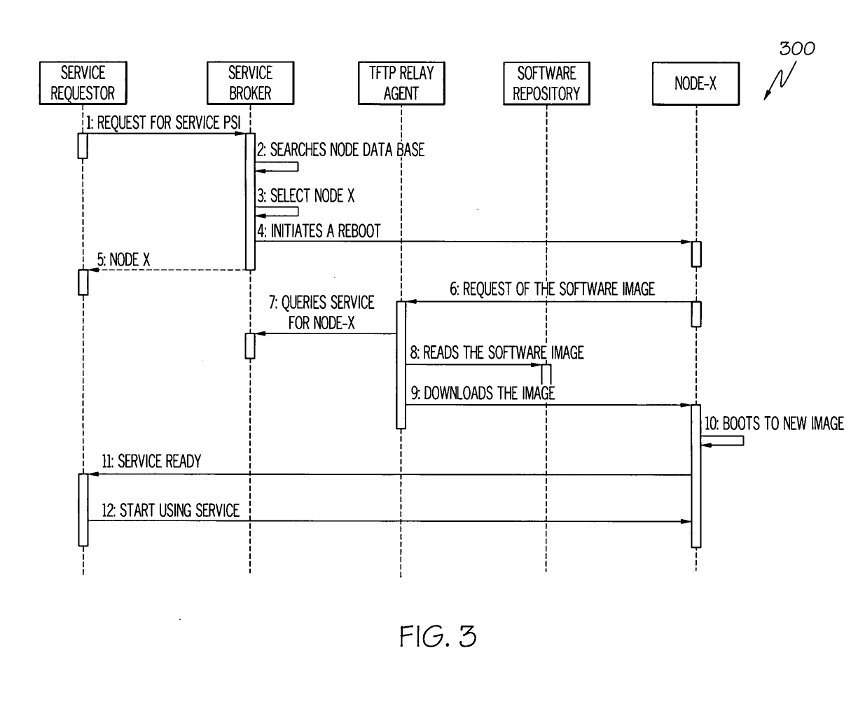

Moving on to FIG. 3, another aspect of the disclosure is disclosed. In particular, an example embodiment of a method and/or system for dynamically loading a service onto a node on a networked computer system is depicted through a sequence diagram 300 having objects and actions depicted thereon. Rather than repeating the contents of this sequence diagram 300, reference is respectfully directed thereto for further example methods and/or systems in accordance with this disclosure, such as those already depicted by FIGS. 1 and 2.

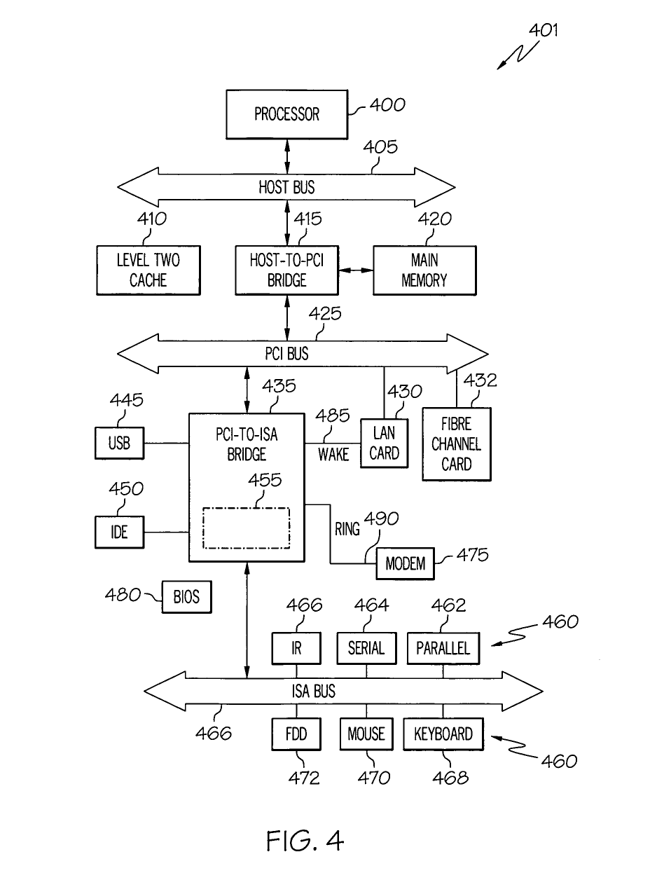

FIG. 4 illustrates information handling system 401 which is a simplified example of a computer system, such as computer 117 or node 125 in FIG. 1, in communication with a networked system computer 105 as shown in FIG. 1 for dynamically loading a service onto a node on the networked computer system 105, and capable of performing the operations described herein. Computer system 401 includes processor 400 which is coupled to host bus 405. A level two (L2) cache memory 410 is also coupled to the host bus 405. Host-to-PCI bridge 415 is coupled to main memory 420, includes cache memory and main memory control functions, and provides bus control to handle transfers among PCI bus 425, processor 400, L2 cache 410, main memory 420, and host bus 405. PCI bus 425 provides an interface for a variety of devices including, for example, LAN card 430. PCI-to-ISA bridge 435 provides bus control to handle transfers between PCI bus 425 and ISA bus 440, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, fixed disk (HDD) 472, removable storage device 474) coupled to ISA bus 440. Alternatively, many I/O devices can be accommodated by a super I/O controller (not shown) attached to ISA bus 440.

BIOS 480 is coupled to ISA bus 440, and incorporates the necessary processor executable code for a variety of low-level system functions and system boot functions. BIOS 480 can be stored in any computer-readable storage medium, including magnetic storage media, optical storage media, flash memory, random access memory, read only memory, and so forth. In order to attach computer system 401 to another computer system to copy files over a network, LAN card 430 is coupled to PCI bus 425 and to PCI-to-ISA bridge 435. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the disclosure described herein, this computer system is simply one example of a computer system. Those skilled in the art will appreciate that many other computer system designs are capable of performing the disclosure described herein, and this is exemplified for the case of transport layer load balancing where a couple to many, many receiving computer systems, i.e., receivers, having different transmission rates of their respective dupacks and ACKs sent over the network to the sending computer system, i.e., sender.

Another embodiment of the disclosure is implemented as a program product for use within a device such as, for example, those systems and methods depicted in FIGS. 1-3. The program(s) of the program product defines functions of the embodiments (including the methods described herein) and can be contained on a variety of data-bearing media. Illustrative data-bearing media include, but are not limited to: (i) information permanently stored on non-writable storage-type accessible media (e.g., read-only memory devices within a computer such as CD-ROM disks readable by a CD-ROM drive); (ii) alterable information stored on writable storage-type accessible media (e.g., floppy disks within a diskette drive or hard-disk drive); and (iii) information conveyed to a computer by a communications medium, such as through a computer or telephone network, including wireless communications. The latter embodiment specifically includes information downloaded onto either permanent or even sheer momentary storage-type accessible media from the World Wide Web, an internet, and/or other networks, such as those known, discussed and/or explicitly referred to herein. Such data-bearing media, when carrying computer-readable instructions that direct the functions of the present disclosure, represent embodiments of the present disclosure.

In general, the routines executed to implement the embodiments of this disclosure, may be part of an operating system or a specific application, component, program, module, object, or sequence of instructions. The computer program of the present disclosure typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of this disclosure. However, it should be appreciated that any particular program nomenclature that follows is used merely for convenience, and thus this disclosure should not be limited to use solely in any specific application identified and/or implied by such nomenclature.

While the foregoing is directed to example embodiments of this disclosure, other and further embodiments of this disclosure may be devised without departing from the basic scope thereof, and the scope thereof is determined by the claims that follow.

What is claimed is:

1. A method for dynamically loading a service onto a node on a networked computer system, the method comprising:
requesting, by a service requester, of a service from a service broker;
selecting, by the service broker, of the node among the nodes on the networked computer system;
re-booting, by the service broker, of the node based on the selecting;
requesting, by the node, of an image from a TFTP relay agent for the service for the node;
querying, by the TFTP relay agent, for a type of the service from the service broker for the node;
downloading of the image for the type of the service from a software repository accessed by the TFTP relay agent to the node;
booting, by the node, to the image;
informing the service requester by the node that the service is ready for use; and
using the service by the node.

2. The method of claim 1, further comprising reading, by the TFTP relay agent, of the image from the software repository before the downloading of the image from the software repository accessed by the TFTP relay agent to the node.

3. The method of claim 1, wherein the querying further comprises locating the image for the downloading.

4. The method of claim 1, wherein the selecting of the node comprises selecting a free and an available node.

5. The method of claim 1, wherein the requesting, by the node, of the image from the TFTP relay agent comprises requesting subsequent to informing the service requester of an identity of the node based on the selecting.

6. The method of claim 1, wherein the requesting comprises sending messages.

7. The method of claim 1, wherein the requesting comprises requesting a file name of the image for the service having a type.

8. A system for dynamically loading a service onto a node on a networked computer system, the system comprising:
the networked computer system comprising a service requester, service broker, a TFTP relay agent, a software repository, and one or more nodes;
the service requester for requesting a service from the service broker;
the service broker for both selecting the node among the one or more nodes and re-booting the node selected by the service broker;
the node requesting an image from the TFTP relay agent for the service for the node;
the TFTP relay agent for querying the service broker for a type of the service for the node, reading the image for the type of the service from the software repository and then downloading the image from the software repository to the node; and
the node for booting to the image, informing the service requester that the service is ready for use, and for using the service loaded on the node.

9. The system of claim 8, wherein the node selected by the service broker comprises a free and an available node.

10. The system of claim 8, wherein the TFTP relay agent comprises one or more servers.

11. The system of claim 8, wherein the service comprises a video driver.

12. The system of claim 8, wherein the service comprises an audio driver.

13. The system of claim 8, wherein the node selected by the service requester comprises a player.

14. The system of claim 8, wherein the image comprises a firmware image.

15. The system of claim 8, wherein the image comprises a software image.

16. A machine-accessible storage medium containing instructions, which when executed by a machine, cause the machine to perform operations for dynamically loading a service onto a node on a networked computer system, comprising:
requesting, by a service requester, of a service from a service broker;
selecting, by the service broker, of the node among the nodes in a computer system;
re-booting, by the service broker, of the node based on the selecting;
requesting, by the node, of an image from a TFTP relay agent for the service for the node;
querying, by the TFTP relay agent, for a type of the service from the service broker for the node;
downloading of the image for the type of the service from a software repository accessed by the TFTP relay agent to the node;
booting, by the node, to the image;
informing the service requester by the node that the service is ready for use; and
using the service by the node.

17. The machine-accessible storage medium of claim 16, wherein the instructions further comprise operations for reading, by the TFTP relay agent, of the image from the software repository before the downloading of the image from the software repository accessed by the TFTP relay agent to the node.

18. The machine-accessible storage medium of claim 16, wherein the instructions for querying further comprise operations for locating the image for the downloading.

19. The machine-accessible storage medium of claim 16, wherein the instructions for requesting, by the node, of the image from the TFTP relay agent comprise instructions for requesting subsequent to informing the service requester of an identity of the node based on the selecting.

20. The machine-accessible storage medium of claim 16, wherein the instructions for requesting comprise instructions for requesting a file name of the image for the service having a type.
